(19) United States
(12) Patent Application Publication
(10) Pub. No.: US 2026/0054228 A1
(43) Pub. Date: Feb. 26, 2026

(54) MIXED-MATRIX MEMBRANES WITH ASYMMETRIC FILLER DENSITY

(71) Applicant: King Abdullah University of Science and Technology, Thuwal (SA)

(72) Inventors: Rifan HARDIAN, Thuwal (SA); Jiangtao JIA, Thuwal (SA); Osama SHEKHAH, Thuwal (SA); Mohamed EDDAOUDI, Thuwal (SA); Gyorgy SZEKELY, Thuwal (SA)

(21) Appl. No.: 19/102,960

(22) PCT Filed: Aug. 14, 2023
(86) PCT No.: PCT/IB2023/058176

§ 371 Date: Feb. 11, 2025

Related U.S. Application Data
(60) Provisional application No. 63/398,026, filed on Aug. 15, 2022.

(51) Int. Cl. B01D 69/14; B01D 61/02; B01D 67/00; B01D 69/02; B01D 69/12

(52) U.S. Cl. CPC B01D 69/14111; B01D 61/027; B01D 67/00091; B01D 67/0016; B01D 69/02; B01D 69/125; B01D 2323/30; B01D 2325/0231

(57) ABSTRACT

Embodiments of the present disclosure describe a mixed-matrix membrane (MMM), and methods of fabricating a MMM, that includes a filler and a seamless polymer matrix forming a first zone and a second zone. The density of the filler is asymmetric with a greater density of filler within the polymer matrix forming the second zone. A MMM of the present disclosure may be an integrally skinned asymmetric (ISA) MMM or a dense MMM. MMMs of the present disclosure may be utilized in numerous industries. e.g., in the field of organic solvent nanofiltration membranes (OSN), gas separation, fuel cell, battery, catalysis, sensors, pharmaceutical, food and beverages, cosmetics, and composite materials, among others.

### BACKGROUND

Mixed-matrix membranes (MMMs) can be simply defined as membranes containing polymer as the matrix with nanoparticles of other materials as fillers. The combination of polymer and nanoparticles in the MMMs includes the functionality and benefits of each constituent. Therefore, MMMs have found its use in many applications, such as gas separation, liquid separation, organic solvent nanofiltration (OSN), water purification, oil/water separation, catalysis, fuel cells, and battery applications, among other applications. MMMs may be classified as either a polymeric integrally skinned asymmetric (ISA) membrane or a polymeric dense membrane. ISA MMMs include dense top layers and macrovoids at the bottom of the MMM. Dense MMMs do not include macrovoids.

### SUMMARY

According to some aspects of the invention, a method of fabrication includes forming one or more first layers from a first solution comprising a first polymer and a first solvent; forming one or more second layers from a second solution comprising a second polymer, a second solvent, and a filler, the one or more second layers being formed on the one or more first layers, wherein the one or more first layers and the one or more second layers form a membrane; and modifying a morphology of the membrane to form a mixed-matrix membrane (MMM). The MMM comprises a seamless polymer matrix that includes: a first zone; and a second zone comprising the filler.

According to other aspects of the invention, a mixed-matrix membrane (MMM) includes a seamless polymer matrix comprising a first zone and a second zone, wherein the second zone comprises filler.

According to additional aspects of the invention, a separation method utilizing a MMM includes contacting the MMM with a liquid feed stream comprising a first solute and a first solvent to separate the first solute or the first solvent from the liquid feed stream.

### BRIEF DESCRIPTION OF THE DRAWINGS

FIG. 1 is a flow chart of a method of manufacturing a mixed-matrix membrane, according to one or more embodiments of the invention.

FIG. 2 is a block diagram illustrating the manufacture of a mixed-matrix membrane, according to one or more embodiments of the invention.

FIG. 3 is a cross-sectional view of an ISA mixed-matrix membrane, according to one or more embodiments of the invention.

FIG. 4A is a cross-sectional view of an ISA mixed-matrix membrane, according to one or more embodiments of the invention. FIG. 4B is a microscopic sectional view of the MMM of FIG. 4A.

FIG. 5 is a cross-sectional view of a dense mixed-matrix membrane, according to one or more embodiments of the invention.

FIG. 6A is a cross-sectional view of a dense mixed-matrix membrane, according to one or more embodiments of the invention. FIG. 6B is a microscopic sectional view of the MMM of FIG. 6A. FIG. 6C is an enlarged view of a portion of the sectional view of FIG. 6B.

FIG. 7 is a view comparing a mixed-matrix membrane as disclosed herein (FIG. 7C) to a pure polymer membrane (FIG. 7A) and to a conventional mixed-matrix membrane fabricated using direct mixing (FIG. 7B).

### DETAILED DESCRIPTION

Conventional techniques utilized to fabricate MMMs include direct mixing of polymers and fillers, in situ growth of nanoparticles within the polymer matrix, electrodeposition, and multilayer casting. Drawbacks of conventional techniques include fillers being distributed throughout the MMM, requiring a solvent that can facilitate the formation of fillers at elevated temperature without dissolving the polymeric membrane under the reaction conditions, requiring solvents with certain electrolytic properties to grow the nanoparticles without deteriorating the polymer, they may only be suitable to fabricate one type of MMM, having a weak interfacial interaction between the nanoparticles layer and the polymer surface because there is no entanglement or mixing between the filler and the polymer matrix, requiring a metal plate electrode as a source of metal for metal organic frameworks (MOFs) fillers, generating an interface between filler and the top layer of the MMM, and/or having a reduced interaction/adhesion between polymeric layers.

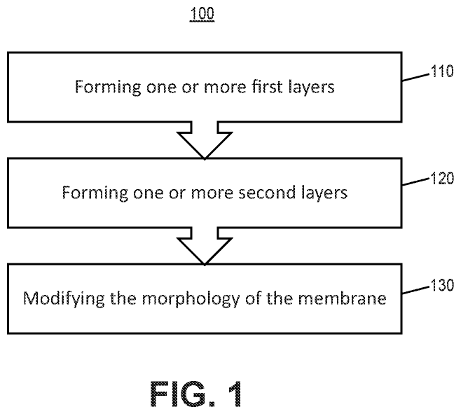

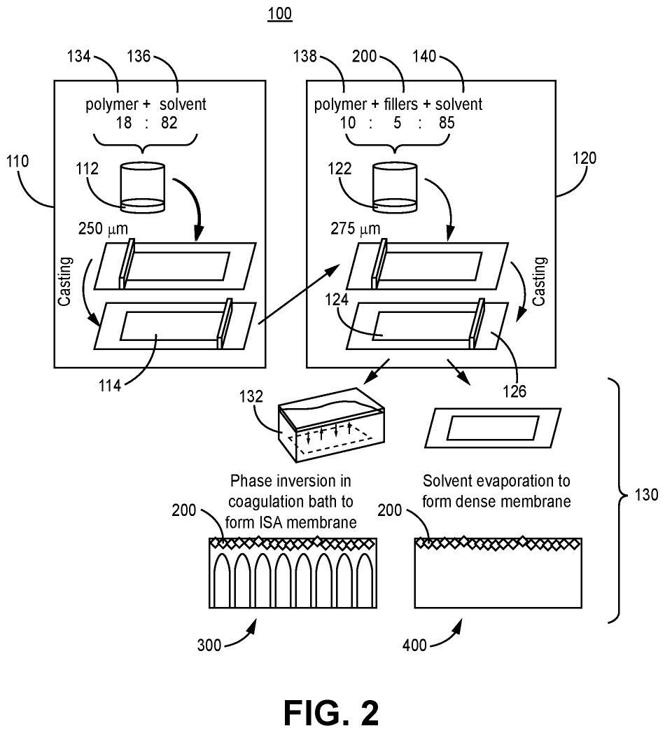

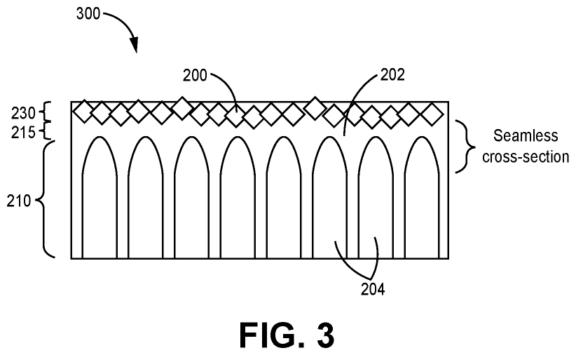

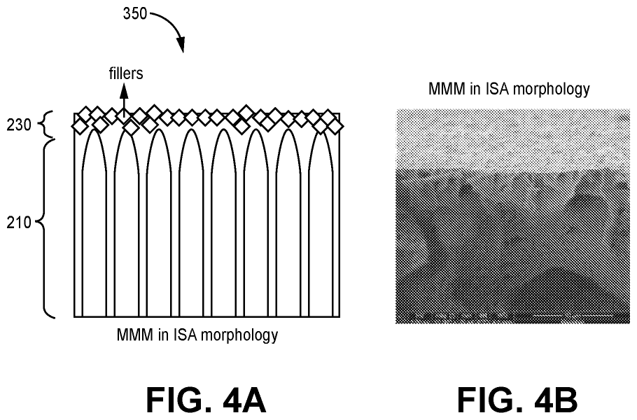

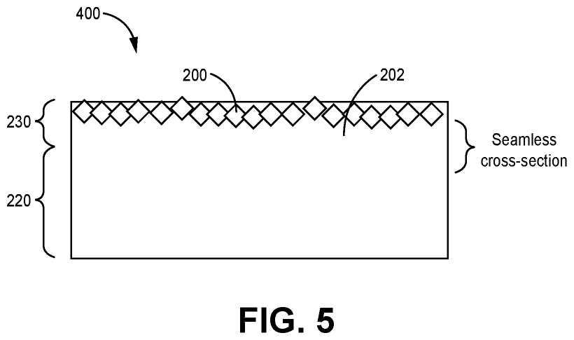

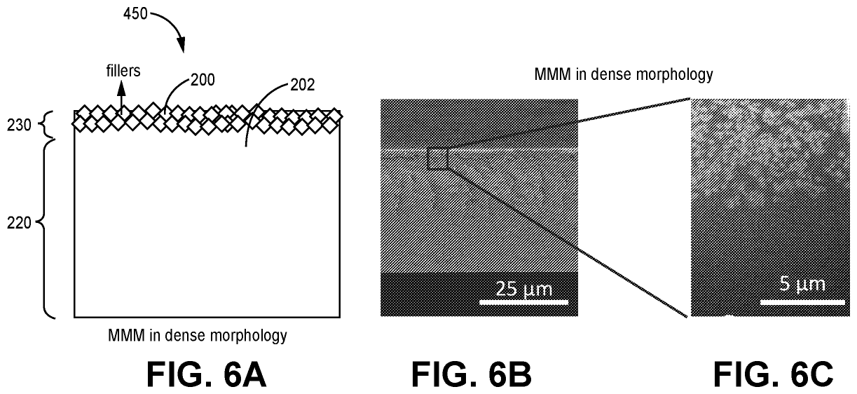

Therefore, there is a need for an alternative methodology to fabricate MMMs. Method 100 as shown in FIGS. 1 and 2 addresses drawbacks of conventional techniques. In one aspect, a MMM fabricated by method 100 includes a seamless polymer matrix 202 (see FIG. 3, for example). Seamless refers to a lack of visual differentiation between two zones or layers, a lack of chemical differentiation between two zones or layers, or both. In another aspect, method 100 may be utilized to fabricate different types of MMMs instead of a single type of MMM. For example, method 100 may be used to fabricate ISA MMMs, as illustrated in FIGS. 3-4, and dense MMMs as illustrated in FIG. 5-6. In another aspect, the method 100 for fabricating MMMs produces MMMs where the density of the filler 200 is asymmetric with the filler 200 primarily or substantially distributed within the second upper zone 230 of the MMM (see FIGS. 3-6, for example). Substantially can include about more than 95%, about more than 98%, about more than 99%, or about more than 99.9%, for example. The filler 200 in the second zone 230 may be distributed substantially equally. In another embodiment, the filler 200 may be substantially distributed with the second zone 230, but distributed unequally. In a further aspect, MMMs fabricated by method 100 have an enhanced performance compared to MMMs fabricated using conventional techniques. For example, method 100 improves solvent flux through the MMM by providing more filler on the second upper zone as transportation channels and reducing or eliminating filler 200 in the first lower zone 210 of the MMM. In an additional aspect, MMMs fabricated by method 100 demonstrated good flexibility and mechanical stability. This may allow the fabrication of MMMs by method 100 to be scaled-up so that the MMMs may be rolled into industrially applicable spiral-wound membrane modules (SWMM).

MMMs fabricated by method 100 may be used for different techniques and/or industries. For example, MMMs fabricated via method 100 may be utilized in numerous industries, e.g., in the field of organic solvent nanofiltration membranes (OSN), gas separation, fuel cell, battery, catalysis, sensors, pharmaceutical, food and beverages, cosmetics, and composite materials, among others.

Turning to FIG. 1, at Step 110, one or more first layers 114 are formed. The first layer 114 may be formed by depositing a first solution 112 and forming a first wet film. In some implementations, the one or more layers 114 are deposited on top of each other so that they may blend/merge to form a seamless polymer matrix 202. In one example, a seamless polymer matrix 202 is fabricated by depositing a subsequent layer 114 before the previous layer 114 starts to coagulate and form an interface. Depending on the characteristics of the first solution 112, a subsequent layer 114 may need to be deposited within a few seconds of the deposition of the previous layer 114 to avoid formation of an interface between the two layers 114. Casting is an example of a technique that may be used to form the first wet film/layer 114 from the first solution 112 (see e.g., FIG. 2).

The thickness of the first layer 114 can range from 1 to 1000 μm. The thickness of subsequent layers 114 may be 0.1 to 1000 μm. In some embodiments, the total thickness of the one or more first layers 114 may be 10-500 μm. In other embodiments, the total thickness of the one or more first layers 114 may be 1-500 μm.

The first solution 112 includes a first polymer 134 and a first solvent 136. In one non-limiting example, the ratio of polymer 134 to solvent 136 in the first solution 112 is 18:82 respectively. The ratio can be about 1:99, 50:50, or any ratio in between. Examples of polymers and solvents that may be utilized for method 100 are discussed below in greater detail.

At Step 120 one or more second layers 124 are formed. The second layer 124 may be formed by depositing a second solution 122 and forming a wet film. In some implementations, the first of the one or more second layers 124 is deposited on the final first layer 114 before the final first layer 114 begins to coagulate. In one aspect, subsequently casting the one or more second layers 124 before the final first layer 114 begins to coagulate produces a seamless transition between the lower zone 210 and the upper zone 230 in the final product 300, 400. This is in contrast to a conventional multilayer technique where the previous layer is dried (e.g., at room temperature or at an elevated temperature) for a period of time before the subsequent layers are cast, which produces a clear interface between the first lower layer and the second upper layer. This is also in contrast to a conventional multilayer casting technique that subjects the previous layer to a phase inversion process (e.g., immersing the first layer in a coagulation media) before casting the subsequent layers, which produces a clear interface between the first lower layer and the second upper layer.

The one or more second layers 124 may be deposited on top of each other so that they may blend/merge to form a seamless polymer matrix 202. In one example, a seamless polymer matrix 202 is fabricated by depositing a subsequent layer 124 before the previous layer 124 starts to coagulate and form an interface. Depending on the characteristics of the second solution 122, a subsequent second layer 124 may need to be deposited within a few seconds of the deposition of the previous second layer 124 to avoid formation of an interface between the two second layers 124. The deposition times may be less than about 60 minutes, less than about 30 minutes, less than about 5 minutes, or less than about 1 min, for example. Casting is an example of a technique that may be used to form the second wet film/layer 124 from the second solution 122 (see e.g., FIG. 2).

The thickness of the second layer 124 can range from 1 to 1000 μm. The thickness of subsequent second layers 124 may be 0.1 to 1000 μm. In some embodiments, the total thickness of the one or more second layers 124 may be 50-300 μm. In other embodiments, the total thickness of the one or more second layers 124 may be 5-100 μm.

The second solution 122 includes a second polymer 138, a second solvent 140, and a filler 200. The second polymer 138 may be the same as the first polymer 134. The maximum concentration of the second polymer 138 depends on the solubility of the second polymer 138 in the second solvent 140. In another aspect, utilizing a second solution that includes a filler 200 to form the second zone 230 eliminates producing an interface between the filler 200 the polymer matrix 202 of the MMM, as may occur with conventional techniques.

The solvent properties of the second solvent 140 may be the same or different from the properties of the first solvent. Solvents utilized for the first and second solutions 112, 122 may be miscible and/or dissolve the polymer 134, 138, while leaving the filler 200 intact. The miscibility of the solvents 136, 140 and the solvent's ability to dissolve the polymer 134, 138 while leaving the filler 200 intact allows the first and second layers to blend/merge to produce a seamless polymer matrix 202, while the fillers 200 remain concentrated in the second layers 124.

The solvent may have a concentration ranging from 80 to 90%. The polymer may have a concentration ranging from 1 to 19%. The filler 200 may have a concentration of 1 to 19%. In some embodiments, the concentration of the polymer dope solution (polymer 138+solvent 140) may range from 1 to 99 wt %, and the concentration of the filler 200 may range from 0.1 to 90 wt %. In further embodiments, the concentration of the polymer dope solution may range from 1 to 50 wt % and the filler 200 may range from 1 to 30 wt %. Some examples for the ratio of polymer, filler 200, and solvent is 10:5:85 respectively include: 1:19:80, 19:1:80, 1:4:95, and 4:1:95. In one non-limiting example, the ratio of polymer, filler 200, and solvent is 10:5:85 respectively. Examples of fillers 200 that may be utilized for method 100 are discussed below in greater detail.

At Step 130, the morphology of at least a portion of the membrane 126 comprising layers 114, 124 may be modified to form either an ISA MMM 300 or a dense MMM 400. An ISA MMM 300 may be formed by phase inversion. A dense MMM 400 may be formed by solvent evaporation.

Phase inversion may include placing the membrane 126 in a coagulation bath 132. The membrane 126 may be soaked in the coagulation bath 132 for 1 to 24 hours. The maximum temperature for the coagulation bath is below the boiling point of the coagulation media. In some embodiments, the temperature of the coagulation bath is 23-150° C. In one example, the coagulation bath 132 may be 23° C. The coagulation media 132 is miscible with the solvents of the first and second solutions 112, 122 and does not dissolve the polymer matrix 202. In one example, the coagulation media 132 does not include a solvent—in other words it is a non-solvent bath. For example, the coagulation media 132 may include water or acetonitrile.

Solvent evaporation (direct evaporation) of at least some of the solvent in the membrane 126 may include placing the membrane 126 at a temperature of 23° C. to 150° C. for 1 minute to 1 week.

In one aspect, to produce a seamless transition between the lower zone and the upper zone, method 100 casts the one or more second layers 124 after casting the one or more first layers 114 without drying or phase inversion of the one or more first layers 114. After the first and second layers 114, 124 are cast, the membrane 126 is subsequently immersed in coagulation media or dried to produce respectively an ISA MMM 300 or a dense MMM 400 with a seamless transition between the lower zone 210 and the upper zone 230.

Optionally, the polymer matrix 202 of the MMM 300, 400 may be cross-linked. In one implementation, the MMM 300, 400 is placed in a bath of cross-linking media (not shown). The non-solvent utilized in the cross-linking media may be the same as, or different than, the non-solvent used in the coagulation media. The cross-linking media may include water, or acetonitrile. In one non-limiting example, cross-linking was implemented with a cross-linking solution that includes a 3 wt % dibromoxylene in acetonitrile at 85° C. for 24 hours.

Optionally, the MMM 300, 400 may be coupled to an additional support layer. The support layer may be coupled to the bottom of the MMM 300, 400. An example of a technique that may be utilized to couple the support member is film casting or film deposition. The additional support layer may be a non-woven porous support. Polypropylene is one example of a material that may be utilized for the non-woven porous support. The additional support layer may be 50-1000 μm thick.

An enlarged view of the ISA MMM 300 in FIG. 2 is provided in FIG. 3. Another embodiment of an ISA MMM 350 that may be fabricated by method 100 is provided in FIG. 4A. An enlarged view of the dense MMM 400 in FIG. 2 is provided in FIG. 5. Another embodiment of a dense MMM 450 that may be fabricated by method 100 is provided in FIG. 6A. Each MMM 300, 350, 400, 450 includes a polymer matrix 202 forming a first zone 210, 220 and a second zone 230 (see e.g., FIGS. 3-6). The polymer matrix 202 of MMM 300 has a seamless cross-section. Thus, the polymer matrix 202 may be described as a seamless polymer matrix 202. In one aspect, utilizing the same polymer for the first and second polymers 134, 138 reduces the formation of an interface between the first zone 210, 220 and the second zone 230.

In some implementations, the polymer matrix 202 in the first (lower) zone 210 includes macrovoids 204 (see e.g., FIGS. 3 and 4A). In other implementations, the polymer matrix 202 in the first (upper) zone 220 is a dense polymer matrix 202 (see e.g., FIGS. 5 and 6A).

The polymer matrix 202 in the second zone 230 includes the filler 200 (see e.g., FIGS. 3-6). In another aspect, the second zone 230 has an equal distribution of filler 200. Depending on the number of second layers 124 deposited at Step 120, the second zone 230 may have more than one layer of filler 200. For example, the MMMs 300, 400 shown in FIGS. 3 and 5 has a single layer of filler 200 while the MMMs 350, 450 shown in FIGS. 4A and 6A have a plurality of filler layers. In some implementations, the fillers 200 are located only in the second zone 230. In one aspect, the amount of filler 200 in the first zone 210, 220 is greatly reduced compared to MMMs fabricated by conventional techniques. The density of the filler 200 may be described as asymmetric—with the density of filler in the second zone 230 being greater than in the first zone.

In some implementations, the MMM 300, 400 may further include a third (intermediate) zone 215 with no macrovoids 204 and no filler 200 (see e.g., FIG. 3). The third zone 215 may be positioned between the first zone 210, 220 and the second zone 230.

In some embodiments, the thickness of the second zone 230 for a MMM to be utilized for liquid separation may be 50-300 μm. In other embodiments, the thickness of the second zone 230 for a MMM to be utilized for gas separation may be 5-100 μm.

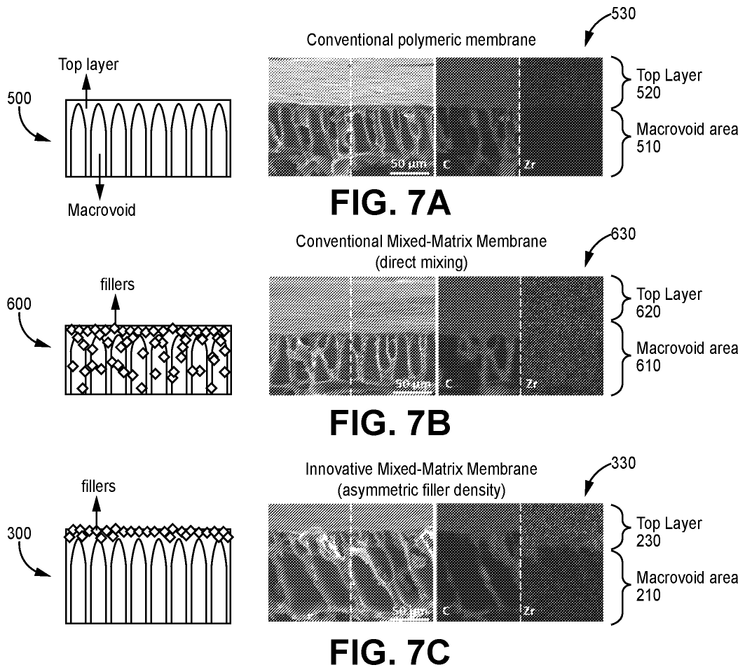

In one aspect, solvent flux by the macrovoids 204 in the first zone 210 is improved because transport resistance caused by the presence of filler 200 in the first zone 210, 220 is reduced or eliminated. Energy dispersive X-ray (EDX) spectroscopy was utilized to confirm that a MMM 300, 400 fabricated by method 100 had a reduced amount or no filler 200 in the first zone 210, 220. EDX identifies the presence of filler 200 (MOF nanoparticles) in the membranes by producing a zirconium (Zr) map representing the distribution of MOF nanoparticles that contains zirconium atom as the building block. For the pure polymer membrane (no filler), no Zr mapping is observed (see photo 530 in FIG. 7A of MMM 500 with a lower macrovoid area 510 and a top layer 520). For conventional MMMs prepared via direct mixing, the Zr mapping is observed everywhere in the membranes' top zone 620 and in the bottom macrovoid zone 610 (see photo 630 of MMM 600 in FIG. 7B). Thus, for the conventional MMM 600, the density of the filler is not asymmetric. In an ISA MMM 300 fabricated by method 100, the Zr mapping observed filler 200 only in the membranes' second (upper) zone 230 (see photo 330 of FIG. 7C of MMM 300). Thus, method 100 reduces or eliminates filler 200 in the first (lower) zone 210, 220.

### Polymers

Polymers that may be utilized to manufacture a MMM by method 100 include any film-forming polymers used for membrane fabrication, such as but not limited to polybenzimidazole (PBI), polybenzoxazole (PBO), polyimide (PI), polydimethylsiloxane (PDMS), polyvinylidene fluoride (PVDF), polyether sulfone (PES), polysulfone (PSU), polyether block amide (PEBA), polyether ether ketone (PEEK), polyethylene (PE), polypropylene (PP), polystyrene (PS), polyacrylonitrile (PAN), cellulose acetate, polyamide, polyaramide, and/or polytetrafluoroethylene (PTFE). The polymers may contain cyclic, aromatic, or aliphatic constituents. Examples of possible polymer structures used as matrix in MMMs, but not limited to:

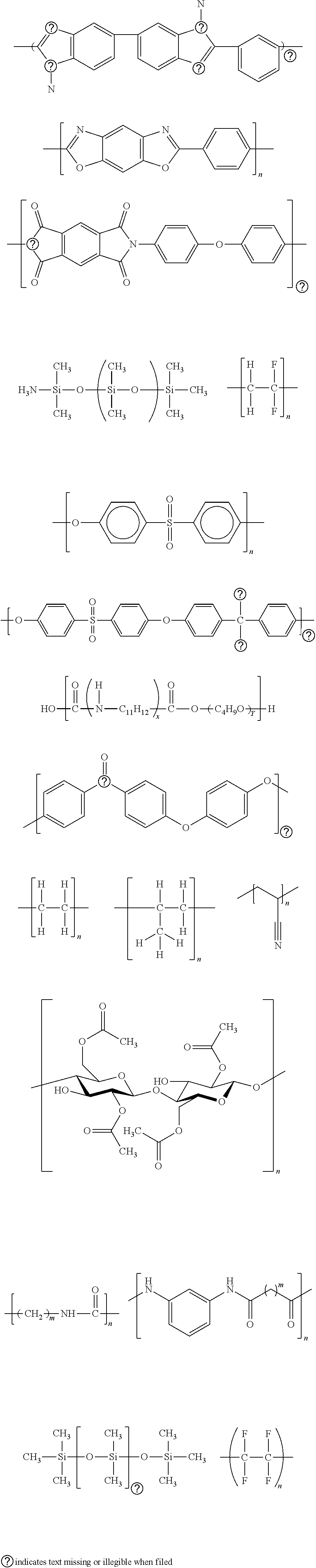

The polymers can be commercial or synthetic whether derived from a natural source or not.

### Fillers

Fillers 200 utilized in the manufacture of a MMM by method 100 may be any chemical substance, in most cases particles, depending on the purpose and application for the MMM to be fabricated. Additionally, the fillers 200 may have any shape (such as but not limited to sphere, cube, octahedral, or undefined shape) and any size ranging but not limited to a few nanometers to a few micrometers. Some non-limiting examples of fillers 200 that may be utilized in method 100 include nanoparticles, such as but not limited to metal organic frameworks (MOFs), metal oxide, metal nanoparticles (gold, platinum, palladium, etc), metal carbides, metal phosphates, metal carbonates, covalent organic frameworks, fullerenes, carbon nanotubes, graphene oxide, silica nanoparticles, and/or many other nanoparticles and microparticles.

A wide range of MOFs may be utilized as fillers 200. Some non-limiting examples of MOFs that may be utilized as fillers 200 include zirconium-based MOFs, zinc-based MOFs, copper-based MOFs, aluminum-based, MOFs, and/or iron-based MOFs.

Examples of zirconium-based MOFs, include, but are not limited to, UiO-66, UiO-67, UiO-68, UiO-66-NH₂, UiO-67-NH₂, and/or UiO-68-NH₂. A non-limiting example of a zinc-based MOF is ZIF-8. A non-limiting example of a copper-based MOF is HKUST-1. A non-limiting example of an aluminum-based MOF is MIL-53 (Al). A non-limiting example of an iron-based MOF is MIL-53 (Fe).

A wide range of metal oxides may be utilized as fillers 200. Examples of metal oxides that may be utilized as fillers 200 include, but are not limited to: aluminum oxide (Al₂O₃), titanium dioxide (TiO₂), zinc oxalate (ZnCo₂O₄), chromium (III) oxide (Cr₂O₃), and/or iron oxide (Fe₃O₄).

Examples of metal nanoparticles (NPs) that may be utilized as fillers 200 include, but are not limited to, gold-NPs, platinum-NPs, and palladium-NPs, etc. Examples of other NPs that may be utilized as fillers 200 include, but are not limited to metal carbides, metal phosphates, metal carbonates, covalent organic frameworks, fullerenes (C₆₀, C₇₀), carbon nanotubes, graphene oxide, and/or silica nanoparticles.

### Solvents

Solvents utilized in method 100 may be commercial or synthetic, whether derived from natural source or not. Examples of solvents that may be used in method 100 include, but are not limited to Dimethylformamide (DMF), Dimethylacetamide (DMAc), N-Methyl-2-pyrrolidone (NMP), Tetrahydrofuran (THF), Dimethyl sulfoxide (DMSO), methyl 5-(dimethylamino)-2-methyl-5-oxopentanoate (e.g., PolarClean), methyl lactate, triethylphosphate, γ-valerolactone, propylene carbonate, butylene carbonate, and/or ionic liquids. Examples of possible solvent structures include:

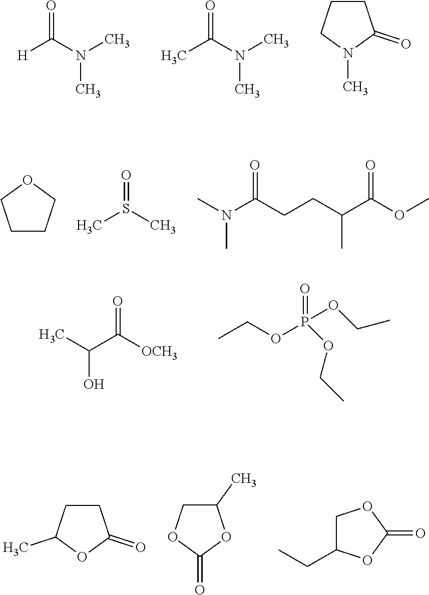

The following Examples are intended to illustrate the above invention and should not be construed as to narrow its scope. One skilled in the art will readily recognize that the inventors suggest many other ways in which the invention could be practiced. It should be understood that numerous variations and modifications may be made while remaining within the scope of the invention.

### Example 1—MMM1

MMM1 was prepared by casting a PBI film made from a dope solution of PBI:DMAc=18:82 wt % with casting thickness of 250 μm followed by casting, on top of the first cast film, another film made from a dope solution of PBI:MOF:DMAc=10:5:85 wt % with the casting thickness of 275 μm to give 25 μm distance between the first casting and the second casting. After that, the formed membrane is directly immersed in an acetonitrile coagulation bath at 23° C. for 24 hours. The MOFs used as fillers 200 in MMM1 had an average size of around 160 nm.

The MMM1 exhibited stability in various solvents, including water, ethanol, methanol, acetone, acetonitrile, toluene, p-Cymene, hexane.

### Example 2—MMM2

MMM2 was prepared by casting a PBI film made from a doped solution of PBI:DMAc=18:82 wt % with casting thickness of 250 μm followed by casting, on top of the first cast film, another film made from a dope solution of PBI:MOF:DMAc=10:5:85 wt % with a casting thickness of 275 μm to give 25 μm distance between the first casting and the second casting. After that, the membrane is directly immersed in an acetonitrile coagulation bath at 23° C. for 24 hours. The MOFs used as fillers in MMM2 had the average size of around 60 nm.

The MMM2 exhibited stability in various solvents, including water, ethanol, methanol, acetone, acetonitrile, toluene, p-Cymene, hexane.

### Example 3—MMM3

MMM3 was prepared by casting a PBI film made from a dope solution of PBI:DMAc=18:82 wt % with casting thickness of 250 μm, followed by casting, on top of the first cast film, another film made from a dope solution of PBI:MOF:DMAc=10:5:85 wt % with the casting thickness of 275 μm to give 25 μm distance between the first casting and the second casting. After that, the membrane was directly immersed in an acetonitrile coagulation bath at 23° C. for 24 hours. Next, MMM3 was immersed in a crosslinking solution that included 3 wt % dibromoxylene in acetonitrile at 85 C for 24 hours. The MOFs used as fillers 200 in MMM3 had an average size of around 160 nm.

The MMM3 exhibited stability in various solvents, including water, ethanol, methanol, acetone, acetonitrile, toluene, p-Cymene, hexane, DMAc, DMF, DMSO.

### Example 4

In another example, polybenzimidazole polymer was utilized for the matrix 202 and Zr-BI-fcu-MOFs were utilized for the fillers 200, where BI=4,4′-(1H-benzo[d]imidazole-4,7-diyl)dibenzoic acid.

The MMMs described in Examples 1˜4 exhibited distribution of fillers 200 only on the top zone 230 of the MMM.

### Separation Performance of MMM1, MMM2, and MMM3

Because MMM1 has a large MOF size and MMM2 has a small MOF size, they may be compared to examine the effect of MOF particle size on the rejection of solutes. Because MMM1 is not cross-linked and MMM2 is cross-linked, they may be compared to examine the effect of crosslinking on the rejection of solutes.

The separation performance of the MMM1, MMM2, and MMM3 membranes was tested with nine molecules: toluene, styrene, p-Cymene, 1-tert-Butyl-3,5-dimethylbenzene, styrene dimer, estradiol, methyl orange, 1,3,5-Tris(4-hydroxyphenyl)benzene, and losartan. The rejection percentage by the membranes for each of the nine molecule is provided in Table 1.

TABLE 1

| Molecule | MMM1 | MMM2 | MMM3 |
|---|---|---|---|
| toluene | 62% | 59% | 78% |
| styrene | 65% | 63% | 81% |
| p-Cymene | 74% | 76% | 85% |
| 1-tert-Butyl-3,5- | 85% | 86% | 89% |
| dimethylbenzene | | | |
| styrene dimer | 95% | 94% | 97% |
| estradiol | 96% | 97% | 98% |
| methyl orange | 99% | 99% | 99% |
| 1,3,5-Tris(4- | 99% | 99% | 100% |
| hydroxyphenyl)benzene | | | |
| losartan | 100% | 100% | 100% |

As illustrated by the results in Table 1, the MOF particle size did not significantly affect the rejection profile. Additionally, for this particular polymer and MOF system, cross-linking did not significantly affect the rejection profile. The data in Table 1 also demonstrate that the MMMs are very tight, which is beneficial for solvent recovery and catalyst recovery applications. The data in Table 1 also indicate that their performance is better than most membranes prepared by conventional methods.

Table 2 provides the results of the amount of acetone flux exhibited by MMM1, MMM2, and MMM3 at different pressures. Solvent flux may be reduced by an increase in transport resistance caused by the presence of fillers 200 in the macrovoid area of the bottom zone 210. The data in Table 2 indicates that the MOF particle size in the MMM significantly affects the permeance with smaller MOF particle size having higher permeance. The data in Table 2 also indicates that crosslinking this particular polymer and MOF system significantly affects the permeance of the MMM with cross-linking reducing the permeance.

TABLE 2

| | Acetone Flux | | |
|---|---|---|---|
| Pressure (bar) | MMM1 | MMM2 | MMM3 |
| 10 | 64 L m⁻² h⁻¹ | 163 L m⁻² h⁻¹ | 33 L m⁻² h⁻¹ |
| 20 | 137 L m⁻² h⁻¹ | 306 L m⁻² h⁻¹ | 72 L m⁻² h⁻¹ |
| 30 | 212 L m⁻² h⁻¹ | 468 L m⁻² h⁻¹ | 107 L m⁻² h⁻¹ |
| 40 | 276 L m⁻² h⁻¹ | 655 L m⁻² h⁻¹ | 149 L m⁻² h⁻¹ |
| 50 | 337 L m⁻² h⁻¹ | 813 L m⁻² h⁻¹ | 178 L m⁻² h⁻¹ |

A MMM fabricated by method 100 may be utilized to separate one or more chemical species. In some embodiments, the separation method includes contacting the MMM with a liquid feed stream comprising a first solute and a first solvent to separate the first solute or the first solvent from the liquid feed stream. The one or more chemical species may be separated by ultrafiltration, nanofiltration, or microfiltration.

The liquid of the feed stream may be an aqueous liquid, an organic liquid, or a combination thereof. Optionally the liquid is wastewater. The liquid feed stream may include one or more additional solvents and/or one or more additional solutes. The first solvent and the one or more additional solvents may be selected from the group consisting of alcohols, methanol, ethanol, isopropanol, butanol, acetone, alkanes, pentane, n-hexane, n-heptane, cyclohexane, alkyl acetates, butyl acetate, ethyl acetate, ethers, methyl ethyl ketone, diethyl ether dichloroethane, chloroform, trichloroethane, methyl isobutyl ketone, formaldehyde, ethylene glycol, propylene oxide, methylene chloride, nitrobenzene, tetrahydrofuran, toluene, diethyl ether, acetonitrile, carbon tetrachloride, xylene, dioxane, dimethyl sulfoxide, dimethylformamide, N-methyl pyrrolidone, and dimethylacetamide.

The first solute may be selected from the group consisting of: sugars, salts, amino acids, flavors, genotoxins, colorants, dyes, pigments, catalysts, peptides, antibiotics, proteins, enzymes, and active pharmaceutical ingredients.

In some implementations, separating may include dead end filtration or cross-flow filtration. In additional implementations, separating may include concentrating the first solute, recovering the first solvent, or a combination thereof.

In some implementations, contacting is performed under an operating pressure greater than 10 bar. Optionally, the operating pressure may be up to about 100 bar.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A method of fabrication comprising:
forming one or more first layers from a first solution comprising a first polymer and a first solvent;
forming one or more second layers from a second solution comprising a second polymer, a second solvent, and a filler, the one or more second layers being formed on the one or more first layers, wherein the one or more first layers and the one or more second layers form a membrane; and
modifying a morphology of the membrane to form a mixed-matrix membrane (MMM);
wherein the MMM comprises a seamless polymer matrix that includes:
a first zone; and
a second zone comprising the filler.

2. The method of claim 1, wherein modifying the morphology of the membrane comprises:
immersing the membrane in a coagulation bath to form an integrally skinned asymmetric (ISA) MMM with macrovoids in the first zone.

3. The method of claim 2, wherein the seamless polymer matrix further includes a third zone positioned between the first and second zones, wherein the third zone does not include macrovoids or filler.

4. The method of claim 1, wherein modifying the morphology of the membrane comprises utilizing solvent evaporation to form a dense MMM.

5. The method of claim 1 wherein the step of forming the one or more second layers begins before a final first layer begins coagulating.

6. The method of claim 1, wherein:
forming the one or more first layers comprises casting one or more layers of first solution, wherein a subsequent layer of the first solution is applied before coagulation of a previous layer; and
forming the one or more second layers comprises casting one or more layers of second solution, wherein a subsequent layer of the second solution is applied before coagulation of a previous layer.

7. The method of claim 1, wherein the first solvent and the second solvent are the same.

8. The method of claim 1, further comprising cross-linking the MMM.

9. The method of claim 8, wherein a non-solvent of the coagulation bath is different from a non-solvent of a cross-linking bath.

10. The method of claim 1, further comprising coupling a non-woven porous support to a bottom of the MMM.

11. (canceled)

12. A mixed-matrix membrane (MMM) comprising a seamless polymer matrix comprising a first zone and a second zone, wherein the second zone comprises filler.

13. The mixed-matrix membrane (MMM) of claim 12, wherein the second zone is 50-300 micrometers thick.

14. The mixed-matrix membrane (MMM) of claim 12, wherein the second zone is 5-100 micrometers thick.

15. The mixed-matrix membrane (MMM) of claim 12, wherein the MMM is an integrally skinned asymmetric (ISA) MMM with macrovoids in the first zone.

16. The mixed-matrix membrane (MMM) of claim 15, wherein the seamless polymer matrix further comprises a third zone positioned between the first and second zones, wherein the third zone does not include macrovoids or filler.

17. The mixed-matrix membrane (MMM) of claim 12, wherein the MMM is a dense MMM.

18. The mixed-matrix membrane (MMM) of claim 12, wherein at least a portion of the polymer matrix is cross-linked.

19. The mixed-matrix membrane (MMM) of claim 12, further comprising a non-woven porous support coupled to a bottom of the MMM.

20. A separation method utilizing a MMM comprising a seamless polymer matrix comprising a first zone and a second zone, wherein the second zone comprises filler, the method comprising: contacting the MMM with a liquid feed stream comprising a first solute and a first solvent to separate the first solute or the first solvent from the liquid feed stream.

21. The separation method of claim 20, wherein separating comprises concentrating the first solute, recovering the first solvent, or a combination thereof.

22. (canceled)
